(19) United States
(12) Patent Application Publication
(10) Pub. No.: US 2024/0349662 A1
(43) Pub. Date: Oct. 24, 2024

(54) A SYSTEM AND METHOD FOR CONTROLLING PLANT GROWTH

(71) Applicant: SIGNIFY HOLDING B.V., EINDHOVEN (NL)

(72) Inventors: Massimo TUMOLO, UTRECHT (NL); Hugo Josè KRAJNC, EINDHOVEN (NL); Fetze PIJLMAN, EINDHOVEN (NL); Judith Hendrika Maria DE VRIES, BUDEL-SCHOOT (NL)

(21) Appl. No.: 18/686,934

(22) PCT Filed: Sep. 12, 2022
(86) PCT No.: PCT/EP2022/075245

§ 371 Date: Feb. 27, 2024

(30) Foreign Application Priority Data
Sep. 14, 2021 (EP) 21196581.9

(51) Int. Cl. A01G 9/26

(52) U.S. Cl. CPC A01G 9/26

(57) ABSTRACT

A system is provided for controlling a time-dependent yield function for a plant or group of plants in a grow facility, in which a local temperature control system locally controls the temperature of one or more regions of a plant or group of plants. The local temperature control system controls the local temperature at at least one of the one or more regions of the plant or group of plants to be different from an overall temperature in the grow facility, to thereby control a time of harvest from the at least one of the one or more regions of the plant or group of plants without affecting the time of harvest from other regions of the one or more regions of the plant or group of plants or from other plants or groups of plants in the grow facility.

### FIELD OF THE INVENTION

This invention relates to the control of plant growth, in particular using temperature control.

### BACKGROUND OF THE INVENTION

There is strong evidence in literature that temperature has a direct impact on the plant growth and time-to-harvest. This applies for both fruit-bearing plants, like tomatoes, for which a higher temperature can lead to a quicker ripening of the fruits, and on flower-bearing plants, for which temperature can influence growth speed and chemical content.

This behavior of plants is often leveraged by growers to reach production targets defined by market demands and contractual commitments. For example, it is common practice to lower a greenhouse temperature to postpone the harvest time in periods with low-demand, and to turn up the temperature later when demand peaks.

The practice of turning up or down a greenhouse temperature to influence the time to harvest has the disadvantage of affecting the entire plant and also all plants in the greenhouse. For example, in a tomato greenhouse, increasing the greenhouse temperature will cause both the lower trusses (close to harvest) and the higher trusses to be affected. Hence, this choice will have effects for around 6 to 8 weeks, and not only on the next harvest. On top of that it will have an influence on all plants and not only on the plants where the grower wants to speed up the harvesting process.

Considering that this practice is used to deal with oscillations in demand, such coarse control is undesired. Instead, it would be desirable to be able to apply granular control to the ripening process, such that short-term strategies can be put into practice.

### SUMMARY OF THE INVENTION

The invention is defined by the claims.

According to examples in accordance with an aspect of the invention, there is provided a system for controlling a time-dependent yield function for a plant or group of plants in a growing environment, comprising:

a local temperature control system for locally controlling the temperature at one or more regions of the plant or group of plants; and

a control system adapted to control the local temperature control system to locally control the temperature at at least one of the one or more regions of the plant or group of plants to be different from an ambient temperature in the growing environment, to thereby control a time of harvest from the at least one of the one or more regions of the plant or group of plants without affecting the time of harvest from other regions of the one or more regions of the plant or group of plants or from other plants or groups of plants in the growing environment.

The term “local control” as used herein also encompasses individual or selective control at the location, meaning that not only the location can be controlled but also the temperature at that location can be controlled, independently from other locations and/or temperatures. For example, the temperature at different locations can be controlled to be different (or the same), enabling individual temperature control of each location.

This system enables a yield of particular harvests at particular times to better match time-dependent demand fluctuations. The time-dependent yield function is a function determining or estimating the expected yield of individual harvests at individual times during an overall harvest period. The harvest period may comprise a plurality of individual harvests at different harvest times. For example, a flat time-dependent yield function may be desirable in case of a constant market demand. Alternatively, a peak in the time-dependent yield function may be desired to correspond to a surge in market demand. Thus, the control system aims to better match the time-dependent yield function to the production demand, over the course of a harvest period by controlling the short term yield without affecting the long term yield. For example, the system can accelerate or slow down the growth of different regions of the plant or group of plants, to alter the time these regions provide harvestable fruit (or flowers) Thus, a yield (in particular the timing thereof) of individual regions of a plant or group of plants is controlled but without affecting the yield (in particular the timing thereof) of other regions of the plant of groups of plants or other parts of the growing environment (i.e. the rests of the harvest). This is also referred to as that “the short term yield is controlled without effecting the long term yield”.

The plants may be considered to comprise different regions, wherein each region is at the same growth stage, e.g., a vegetative stage, a reproduction stage, a flowering stage, a fruit development stage, a fruit ripening stage, a harvest-ready stage, etc. A growth stage may also encompass a general plant development stage or a fruit/flower development stage. By providing local temperature control to one or more of those plant regions (e.g. the bottom of the plants), the harvest time for those plant regions can be controlled to move closer or further away, without influencing the harvest time of the other parts of the plant or group of plants or other plants which are exposed to the ambient temperature of the growing environment, for example, the greenhouse of indoor farm.

The local temperature control system for example comprises a plurality of strings of temperature control elements placed between the plants.

The different regions for example comprise different heights of the plant. For example, for tomato plants, the lower tomato trusses ripen first, and the higher tomato trusses ripen later.

By way of example, the system may be used to increase the temperature of the lower trusses (e.g., tomato trusses) of only some of the plants (e.g., tomato plants), to achieve for the next week a target yield slightly higher than normal, with no long-term effects on the yield from other trusses of the plant or other plants.

The local temperature control system for example comprises a set of one or more horizontal heating structures placed close to, adjacent to or in between the plants. The horizontal heating structures thus conditionally apply heat to a particular height of the plants.

The local temperature control system for example comprises a radiation delivery system. The radiation delivery system may use radiation in different spectra, including the visible light spectrum, and may for example comprise red light, infrared light, and blue light. Blue light is known to penetrate fruit deeper leading to a higher temperature increase, whereas infrared light enables more rapid heating.

The local temperature control system may further comprise a cooling system. Thus, growth rate or fruit development rate differences between different regions of the plants may be achieved with heating and/or cooling some regions of the plant or group of plants while keeping other regions of the plant or group of plants under ambient temperature control of the growing environment.

The cooling system for example comprises a cool air delivery system or a cold water pipe system for local cooling. The cooling system may instead comprise a water spray system for local cooling.

An ambient temperature control system for controlling the temperature in a growing environment may be provided. The ambient temperature control system may be implemented by an already-existing overall climate control system for the growing environment (greenhouse or indoor farm). The ambient temperature control system may be controlled taking account of the local heating conditions to be applied such that desired temperature differences between different regions of a plant or group of plants or between different plants can be achieved. For example, the ambient temperature can be lowered, creating a lower baseline temperature for the plant or group of plants, and only local heating is used to provide the desired temperature variations between different plant regions or different plants.

The local temperature control system may comprise spectrum tunable radiation sources. These may be used for irradiating specific regions of the plant or groups of plants with particular radiation, for example different at the top and bottom of the plant or group of plants.

The system may further comprise a sensor system for monitoring:

a growth stage of the one or more regions of the plant or group of plants; and/or

a temperature at the one or more regions of the plant or group of plants.

In this way, the control can be automated, with the system being able to estimate the expected harvest time for different plant regions from sensing of the growth stage for these regions. The temperature sensing may also be used to ensure that damage to the plant due to excessive temperature exposure is avoided, for example the temperature can be prevented from reaching above a temperature limit.

The sensor system for monitoring a growth stage for example comprises:

a camera and computer vision system; or

an RF sensing system for detecting fruits or flowers based on a water density.

The control system may comprise:

an input interface for receiving an indication of a desired harvest time for a portion of the yield from the plant or the group of plants; and

an output interface to control the local temperature control system to achieve the desired harvest time for the portion of the yield from the plant or group of plants.

The desired harvest time for a portion of the yield from the plant or group of plants may be deduced from a desired time-dependent yield from the plant or group of plants in the growing environment.

Thus, the local temperature control is automated to achieve a desired harvest time for a portion of the overall yield.

The control system may comprise a yield forecasting algorithm, and the control system is adapted to obtain a yield forecast taking into account the effect of the applied local temperature control.

The invention also provides a method for a time-dependent yield function for a plant or group of plants in a growing environment, comprising:

receiving an indication of a desired harvest time for a portion of the yield from a plant or a group of plants;

controlling a local temperature control system to control the local temperature at at least one of one or more regions of the plant or group of plants to be different from an ambient temperature in the growing environment, to thereby control a harvest time from the at least one of the one or more regions of the plant or group of plants without affecting the harvest time from other regions of the one or more regions of the plant or group of plants or from other plants or groups of plants in the growing environment.

The invention also provides a computer program comprising computer program code which is adapted, when said program code is run on a controller of the system, to implement the method defined above.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a system for controlling plant growth; and

FIG. 2 shows a method for controlling plant growth.

### DETAILED DESCRIPTION OF THE EMBODIMENTS

The invention will be described with reference to the figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the figures are merely schematic and are not drawn to scale. It should also be understood that the same reference numerals are used throughout the figures to indicate the same or similar parts.

The invention provides a system for controlling a time-dependent yield function for a plant or group of plants in a growing environment, in which a local temperature control system controls the temperature of a plant of group of plants at different regions of the plant or group of plants. The local temperature control system comprises at least a local heating system. The time-dependent yield function for the plant or group of plants is controlled during the course of a harvest period, so that demand fluctuations can be met. In particular, rather than controlling the temperature of the whole of the plant or group of plants in the growing environment, the temperature at different regions of the plant or group of plants is controlled separately. In particular, the development or ripening of regions in the same growth stage may be accelerated or retarded.

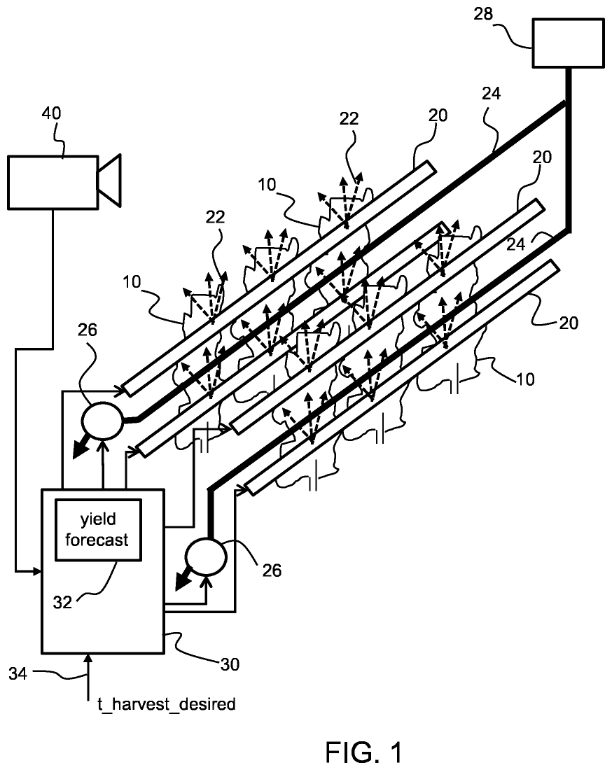

FIG. 1 shows a system for controlling the growth of a set of plants 10 within a controlled growing environment such as a greenhouse. The invention is for use in horticulture farming.

The plants 10 are arranged as groups, for example each group may be a row of plants, or there may be a fraction of a row of plants forming a group, or there may be multiple rows forming a group. The plants 10 may also be arranged as single plants. Although not shown in FIG. 1, the plants may be stacked vertically as well as being distributed over a horizontal area.

For simplicity, FIG. 1 shows two rows of plants, and each row is a group. Each plant in each group has a top region and a bottom region.

A local temperature control system is provided for controlling the temperature of each group of (one or more) plants at those different regions of the plant or plants of the group.

FIG. 1 shows an arrangement in which the local temperature control system comprises horizontal heating bars 20. The heating bars are placed between and among the plants.

Each heating bar 20 is for heating the plant or group of plants at a particular vertical height of the plant or group of plants; one heating bar 20 is for heating near the bottom of the plant or group of plants and another heating bar 20 is for heating near the top of the plant or group of plants. For some plants, such as tomato plants, are arranged such that lower fruit reaching ripeness first compared to higher located fruit. Different heights of the plant may then be considered to be in the same growth stage or fruit development stage. Thus, by providing local heating only to regions of the plant or group of plants at a particular height, the harvest time for those regions (as a whole) can be controlled, without influencing a harvesting time of other regions of the plant.

More generally, there may be different regions of a plant at the same growth stage and there may be different ways these regions grow towards harvest. For fruit-bearing plants, a region can be a truss flowering, a region can be fruit of a first color (e.g. green tomatoes), and a region can be fruit of a second color (e.g. red tomatoes near harvest). A temperature control strategy may be applied to each region to accelerate or delay its growth.

FIG. 1 also shows an optional cooling system comprising cooling bars 24. The cooling bars for example comprise water pipes, and pumps 26 (or one pump and a set of valves, not shown) are provided for pumping cold water along the cooling pipes, from a cold water supply 28. In another example, the cooling system comprises a cool air delivery system or a water spray system for local cooling.

The cooling system may provide local cooling to different regions of a plant or group of plants. However, the cooling system may instead comprise an ambient temperature control system for controlling the temperature of the entire plant or group of plants. In this way, the ambient temperature may be lowered, and only local heating is used to provide the desired temperature variations between different plant regions.

By way of example, for tomatoes, by increasing the temperature of the lower trusses of a tomato plant or group of tomato plants, a ripeness of those lower trusses is reached earlier but with no long-term effects on other trusses or flowers of the tomato plant or group of tomato plants.

A control system 30 controls the local temperature control system 20, 24 thereby to control the time-dependent yield function of a plant or group of plants during the course of a harvest period. The harvest period may comprise a plurality of individual harvests at different harvest times. The control system may accelerate or retard (bring forward or delay) the harvest time for a portion of the harvest within the harvest period (e.g. accelerating 20% of the harvest so that it happens a week earlier). The control system may control the application of local heating and optionally also cooling, based on a particular harvesting strategy. Additionally, the control system 30 can present the greenhouse temperature conditions to the grower (e.g., as a 3D heat map) as a support to assist the grower in formulating the growth strategy.

The control system for example makes use of an existing yield forecasting algorithm 32.

The controller 30 receives at an input interface 34 a desired harvest time (t_harvest_desired). This is for example a particular time at which a particular harvest amount (volume or mass or fraction of complete harvest) is needed, to meet known future market demands. The controller 30 then devises a heating (and optionally also cooling) strategy for the different plant regions to enable the desired harvest to be achieved at the desired time.

The system enables a yield at a particular harvest to be controlled to match the demand fluctuations over time. The time-dependent yield function is the amount of (available) yield at different times during an overall harvest period. Thus, the control system aims to better match the time-dependent yield function to the production demand, especially to the short term fluctuations in the production demand.

The system can accelerate or slow down growth of different regions of the plant or group of plants, to alter the time the plant or group of plants provide a harvestable yield. Thus, short term yield is controlled (in particular, the timing thereof) but without affecting the long term yield (i.e., for the rest of the harvest).

In addition to the local temperature control for individual plant regions, a control loop will also be provided for managing the overall growing environment (e.g., greenhouse) temperature. For example, instead of trying to increase the temperature of one or more regions of a plant or groups of plants by 10 degrees Celsius, when the radiation treatment can only reach up to 6 degrees Celsius, the growing environment climate control management system could increase the ambient temperature in the growing environment by 4 degrees Celsius. In this way, local heating can reach the desired 10 degrees Celsius at the desired one or more regions of the plant or group of plants, and local cooling by 4 degrees Celsius can be applied at other regions of the plant or group of plants to compensate for the overall growing environment temperature increase.

The local heating may for example be achieved using grids of pipes carrying hot water, placed at different heights such that multiple regions at different heights are covered. However, in the example of FIG. 1, the heating bars 20 are for providing radiation 22. The output for different heating bars may have different spectra, or the radiation output may be tunable.

The different regions of the plant or group of plants may be defined manually, for example based on defined heights as explained above. However, FIG. 1 shows an optional alternative in which computer vision strategies are employed using cameras 40 (only one is shown) positioned around the glow environment (greenhouse). Image analysis may be used to identify the growth stage for example based on the color and/or size of fruit/flowers/buds. RF-based strategies may also be used to identify regions with higher density of water, corresponding to degrees of ripeness.

For radiation based heating, different radiation elements may then be actuated to correspond to the locations of the plant regions identified by the camera system.

There are additional measurements that can be taken to provide information relating to the growth stage of plants, such as by determining the average growth stage for all the plants of the growing environment based on the analysis of overall water and/or nutrient intake.

The local heating control using radiation may employ a plant-specific radiation spectrum, directed towards certain regions of the plant. The radiation may be visible light such as blue or red, or it may be invisible such as infrared.

The intensity of the radiation used for heating may also be dependent on how dense the foliage of the plant is. For example, two plants may be similar in terms of suitable radiation spectrum, but if one has very thin or sparse foliage while the other has very thick or dense foliage, the same intensity of light will have different effective growth impacts. Thus, the intensity can be adapted to reach the desired growth targets.

As will be clear from the discussion above, the invention is based on identifying different plant regions and applying local heating and optionally also cooling (local or general) to achieve a particular time-dependent harvest outcome. These aspects will be described in further detail below.

### Identification

The system requires different regions of the plants to be identified. Each region is preferably one or more portions (e.g. trusses, flowers, . . . ) of a plant at the same growth stage, or, pragmatically, equally distant in time from the harvest time. However, even roots of a plant can function as a plant region for which temperature control can be used. Local heating or cooling of the roots will lead to a more or less efficient water intake. The heating or cooling intervention locally changes the maturation speed of each individual region. Thus, the growth stage cannot simply be defined by the age of the plant, as different plants will have different stages at the same age, or a single plant may be at a different stage than is expected for its age.

In a most basic example, the identification can be performed manually by the farmer, specifying how the plants should be divided into regions. The farmer can also, on an as-needed basis, define which regions should be targeted by the local heating and/or cooling. For example, given a short-term forecasted peak in demand, the farmer may define that the lower part of all plants should receive an increased level of heat. This will not influence the upper part of the plant, hence the harvest results after the demand peak. In another example, given a long-term (e.g., 5 week) demand-peak forecast, the farmer may want to speed up the flowering process and locally heat the upper part of the plant and possibly cool down the lower part.

Computer vision may alternatively (or additionally) be used for identification as mentioned above. Based on the complexity of the harvesting strategy, a number of cameras can be deployed through the growing environment to collect pictures to be processed. A complex strategy (different plants treated with different treatments) requires a higher number of cameras than a simple strategy (all plants treated the same). In the latter case, cameras can be positioned to monitor one or more sample plants, representative of the whole greenhouse. The number of sample plants required will increase with the increasing strategy complexity.

A computer vision algorithm may be used to recognize features typical of a certain growth stage thereby to classify the regions of the plant. In a tomato greenhouse, this can include certain heights of the plants on which tomatoes have a certain color or are not present at all. In a cannabis cultivation, this can be based on the presence of buds, or on their features or color, or on the bud size. In a rose cultivation, this can be based on the height and size of the flowers.

RF sensing can also be used to recognize the presence of fruits or flowers, given the higher density of water in these. For example, RF nodes embedded in a lighting infrastructure or in the described radiation infrastructure can be used to measure RF levels with respect to each other and determine the expected amount of biomass between their defined sensing space. In those regions where significant differences in biomass are detected, the heating can be applied.

Sensors may also be used, for example integrated into an irrigation system, to analyze the water intake, the wastewater and its nutrient content, and the humidity (evaporation) to infer the growth stage of one or more grouped plants. Such a system could reveal if specific groups are at a different growth stage (e.g., lagging behind) the average of the greenhouse, and localized heating or cooling could be applied to normalize the overall growth.

### Local Heating

A harvesting strategy for example may require a target production amount to be harvested during a target week, which is a greater production amount than would be achievable in normal conditions. The strategy is thus implemented by selectively heating the regions of the plants that in normal conditions would not be ready to be harvested by the time of the target week, but which can reach harvest with heating with no damage to the plant.

The amount of the heat provided to the plant has to be maintained within reasonable boundaries to avoid damaging the plant itself or force over-ripening of the fruit, such that the produce would arrive already expired to the market.

The local heating is in preferred examples implemented using a plant-specific radiation spectrum. The radiation may be specific for each crop type and variety. The required temperature change to achieve a shorter time-to-harvest is usually small enough that heating changes caused by radiation is able to provide the desired change in harvest times. Different spectra may be used to provide the required control and adjustment of the local heating conditions. For example, infrared may be used for a main portion of the heating period, e.g. 80%, as it quickly accelerates growth, and blue light may be used for the remaining time as it is easier to dose and generates more controllable heating (and hence avoid temperature overshoot).

The radiation may be embedded in ground level lighting (so-called interlights or intra canopy lights which produce lines of light that are positioned in between plants for providing light to the lower parts of the plants) and/or in the top level lighting, and optionally at intermediate levels within the plant height. The different radiation elements embedded in the lighting can be selectively enabled and disabled. The radiation may be mechanically oriented to face the plants, or else the radiation may use multiple arrays with different orientations and the orientation could then be embedded in the luminaires and selectively enabled.

### Local Cooling

A harvesting strategy for example may require a target production amount to be harvested during a target week, which is a lesser production amount than would be achieved in normal conditions. The strategy is thus implemented by selectively cooling the regions of the plants that in normal conditions would be ready to be harvested sooner than the time of the target week, but which can be postponed with cooling with no damage to the plant. The amount of the cooling provided to the plant also has to be between reasonable boundaries to avoid damaging the plant itself.

As mentioned above, local cooling may use local jets of cool air oriented towards specific regions, or (if the growing environment allows it), grids of pipes that carry cold water sized in a way that the temperature change can be contained in a reasonably small region.

In another embodiment, a water evaporation system may be integrated into the lower level lighting (the so-called interlights or intra canopy lights). By spraying small droplets towards the lower parts of the plants, the fruits are effectively cooled. Moreover, the cooling of the local environment also leads to in an increase of the LED efficiency of the lighting.

By reducing the ambient temperature set point for the greenhouse, combined with dedicated heating of a selected plants, most of the plants will not meet the harvesting time thereby avoiding waste, and the selectively heating means the desired harvest amount can be achieved.

The radiation may have a tunable spectrum. The grower inputs to the control system the harvest goals, and the system decides how to balance the radiation from the interlights or intra canopy lights and from the top lights. When the plants would produce insufficient harvest under normal conditions, the radiation from the top lights is dimmed and their reduction of radiation is transferred to the interlights. Increasing the radiation levels between the plants increases the heating level (since the radiation element, such as LEDs, produce heat). Moreover, by tuning the radiation spectrum towards blue, the fruits can be made to absorb more of the radiation.

### Control System

The control system is in charge of coordinating identification, heating, and cooling. The control system receives a target from the grower, for example requiring the harvest to be accelerated, and the control system evaluates its feasibility of the targets, i.e., if the target can be executed given the boundaries by which the harvest can be postponed or accelerated. A control strategy is devises and followed if there is a feasible strategy. The strategy defines, for each identified region, if and when and for how long the heating and cooling should be applied.

The heating and cooling may be regulated using feedback, for example using a temperature sensor for sensing a temperature at the different regions of the plant or group of plants. The temperature sensing example ensure that damage is not caused due to excessive temperature or cooling, for example the temperature can be prevented from reaching above or below temperature limits.

The heating and/or cooling system may be implemented as part of an interlight or intra canopy light system or top light system, or else it may be a separate system to the luminaires.

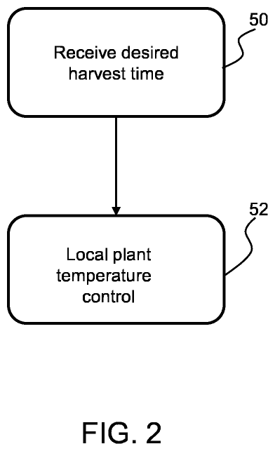

FIG. 2 shows a method for controlling a time-dependent yield function for a plant or group of plants in a growing environment, comprising:

in strep 50, receiving an indication of a desired harvest time for a portion of the yield from a plant or a group plants; and

in step 52 controlling a local temperature control system to control the local temperature at at least one of one or more regions of the plant or group of plants to be different from an ambient temperature in the growing environment, to thereby control a harvest time from the at least one of the one or more regions of the plant or group of plants without affecting the harvest time from other regions of the one or more regions of the plant or group of plants or from other plants or groups of plants in the growing environment.

The method is implemented by software running in the control system 30.

As discussed above, embodiments make use of a controller. The controller can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

Although the invention has been described with reference to tomato plants that may have different regions of the plant in different growth stages or different fruit development stages, the invention is not limited to such type of plants, nor to fruit-bearing plants in general. The claimed invention is also applicable to non-fruit-bearing crops where temperature control may be applied to control the (remaining) time to harvest of individual crops. In such examples, the local temperature control system may be adapted to locally control the temperature at the level of the individual crop or at the level of a group of crops.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

If the term “adapted to” is used in the claims or description, it is noted the term “adapted to” is intended to be equivalent to the term “configured to”.

Any reference signs in the claims should not be construed as limiting the scope.

1. A system for controlling a time-dependent yield function for a plant or group of plants in a growing environment, comprising:
a local temperature control system for locally controlling the temperature at one or more regions of the plant or group of plants; and
a control system comprising:
an input interface for receiving an indication of a desired harvest time for a portion of the yield from the plant or group of plants,
an output interface to control the local temperature control system to achieve the desired harvest time for the portion of the yield from the plant or group of plants, and
the control system being adapted to achieve the desired harvest time for the portion of the yield from the plant or group of plants by locally controlling the temperature at at least one region of the one or more regions of the plant or group of plants to be different from an ambient temperature in the growing environment to accelerate or slow down the growth of the plant or group of plants at the at least one region of the one or more regions without affecting the time of harvest from other regions of the one or more regions of the plant or group of plants or from other plants or groups of plants in the growing environment.

2. The system of claim 1, wherein the local temperature control system comprises at least a local heating system.

3. The system according to claim 1, wherein the different regions are different heights of the plant.

4. The system according to claim 1, wherein the local temperature control system comprises a set of one or more horizontal heating structures placed between the plants.

5. The system according to claim 1, wherein the local temperature control system comprises a radiation delivery system.

6. The system of claim 5, wherein the radiation delivery system comprises spectrum tunable radiation sources.

7. The system according to claim 1, wherein the local temperature control system further comprises a cooling system.

8. The system of claim 7, wherein the cooling system comprises a cool air delivery system, a cold water pipe system or a water spray system for local cooling.

9. The system according to claim 1, further comprising an ambient temperature control system for controlling an ambient temperature for the plant or group of plants in the growing environment.

10. The system according to claim 1, further comprising a sensor system for monitoring:
a growth stage of the one or more regions of the plant or group of plants; and/or
a temperature at the one or more regions of the plant or group of plants.

11. The system of claim 10, wherein the sensor system for monitoring a growth stage of the one or more regions of the plant or group of plants comprises:
a camera and computer vision system; or an RF sensing system for detecting fruits or flowers based on a water density.

12.-13. (canceled)

14. A method for controlling a time-dependent yield function for a plant or group of plants in a growing environment, comprising:
receiving an indication of a desired harvest time for a portion of the yield from the plant or group of plants; and
controlling the desired harvest time for the portion of the yield from the plant or group of plants by controlling a local temperature control system to control a local temperature at at least one region of one or more regions of the plant or group of plants to be different from an ambient temperature in the growing environment to accelerate or slow down growth of the plant or group of plants at the at least one region of the one or more regions and without affecting the time of harvest from other regions of the one or more regions of the plant or group of plants or from other plants or groups of plants in the growing environment.

15. A non-transitory computer readable medium comprising instructions, the instructions when executed by a processor of a control system, cause the processor to perform the method of claim 14.

16. The system of claim 1, wherein the control system comprises a yield forecasting algorithm, and the control system is adapted to obtain a yield forecast taking into account the effect of the applied local temperature control at the at least one region of the one or more regions of the plant or group of plants.
